(19) United States
(12) Patent Application Publication
(10) Pub. No.: US 2003/0041729 A1
(43) Pub. Date: Mar. 6, 2003

(54) Method and apparatus for cleaning filter bags of bag houses

(76) Inventor: Justin J. Finigan, Greeneville, TN (US)

Correspondence Address: Justin J. Finigan, 275 Woodcrest Dr., Greeneville, TN, 37745, US

(21) Appl. No.: 10/142,759

(22) Filed: May 9, 2002

Related U.S. Application Data
(63) Continuation-in-part of application No. 09/474,584, filed on Dec. 29, 1999, now abandoned.

(51) Int. Cl. B01D 46/04

(52) U.S. Cl. 95/26; 95/280; 96/428; 55/302; 55/283

(57) ABSTRACT

Bag house construction wherein groups of bags are substantially isolated from other groups of bags by partitions to provide a substantially separate cell for each group of bags, whereby each cell can be selectively taken off-stream to render the cell passive for a finite period of time to enhance gravitational migration of floaters and other suspended particles toward a hopper, and whereby bag cleaning air at ambient conditions can be sent down into the bags and out thru the fabric filtering media thereof at a substantially even flow without impedance from upwardly flowing, turbulent feed air.

### BACKGROUND OF THE INVENTION

This application is a continuation-in-part of Applicants pending Serial No. 09/474,584 filed Dec. 29, 1999 of same title.

1. Field

This invention concerns the cleaning of filter elements including filter bags (term includes cartridge filters) commonly employed in bag houses, particularly in large facilities which house multiple groups, i.e., rows or banks of such bags which may be supported substantially vertically or horizontally in a collector housing by wire retainers (frames) or, in the case of cartridge filters which are self-supporting, by cartridge holders or the like, suspended from or positioned on an overhead horizontal or otherwise postured tube sheet (cell plate). The feed air which carries filterable dust or other particles is fed by suction into a hopper below the collector housing and heavier particles drop out of the air feed stream in the hopper from which they are removed thru an airlock or other conventionally employed discharge port structure positioned typically at the bottom of the hopper.

The feed air with lighter particles entrained therein is sucked upwardly into the collector housing typically by a suction fan communicating with the outlet of a filtered air plenum which is normally in communication with the open tops of the bags. This feed air is then sucked thru the filter bag fabric walls into the interiors of the bags and then out thru the open bag tops to the outlet of the clean (filtered) air plenum.

This filtering operation results in a build-up of particulate matter on the bag walls, particularly the exterior (upstream) surfaces thereof, and eventually reduces the feed air flow rate thru the bag walls and to the filtered air plenum to an unacceptable, inefficient level. Periodic cleaning of the bags is thus essential for productive commercial operations.

2. Prior Art

Heretofore cleaning of the bags has been done primarily by jetting or pulsing a clean air stream down thru the open top of the bags to vigorously force the bag walls outwardly from their supporting frames. Such pulses are of a very short duration, e.g., fractions of a second, and are intended primarily to shock the bags to release collected particles adhering to the outer surfaces of their walls. It is believed that essentially no pulsed air flows out thru the fabric walls of the bags, however, if there is any, it is met by the upward air flow pressure and the momentum and dynamic motions of feed air impinging on and surrounding the bags being cleaned. Such construction is shown in U.S. Pat. No. 3,963,467 the disclosure of which is hereby incorporated herein in its entirety, and wherein the feed air turbulence around the exterior of the bags being cleaned does not lend to settling or migrating of particles downwardly to the hopper discharge port.

Other bag house constructions which provide various types of bag cleaning devices are shown in U.S. Pat. Nos. 4,292,053; 4,046,526; 5,269,835; 4,681,607; 3,057,137; 3,430,419; 3,266,225; and 3,975,173, the disclosures of which regarding bag house constructions and their use and operation are hereby incorporated herein by reference in their entireties.

In all of the above prior installations and their operations, significant shortcoming in regard to filtering out lighter dust particles and floaters is noted. Also, the reintrainment into the upstream feed air of dust which has become loosened during pulse-jet cleaning from adjacent bags markedly reduces efficiency of the operation. In this regard, with some prior designs, such phenomena actually necessitates limiting the feed air inlet flow rate such as to reduce the feed air turbulence in the bag vicinity during the bag cleaning cycle. Further comments regarding prior cleaning systems and methods are given below.

### SUMMARY OF THE INVENTION

The present invention overcomes many of the problems associated with bag cleaning in general, and particularly with lighter particles, floaters, reintrainment and the like and may be summarized in one important embodiment as comprising a unique bag house construction wherein the filter bags are divided into groups wherein each group is separated from all other groups by partitions or walls which extend from the tube sheet of the collector unit to at least near the bottoms of the bags to form a separate cell for containing each group. This construction allows each cell and its associated bags or cartridges or other filter elements to achieve a state of quiescence when a flow control damper or valve means closes off communication of the cell with the clean air (filtered) exhaust plenum, i.e., takes the cell off-line, whereby floaters or other particulates will tend to gravitate to the hopper. Then, with the cell in a quiescent state, albeit for only a short period of time, when another damper or valve means connects the bags and cell to a substantially steady stream of bag cleaning air at ambient pressure (about 14.7 lb/in.²), a pressure higher than the negative static feed air pressure in the hopper which typically is about 4.0 in. spwg, particulate matter will be carried downwardly by the cleaning air flowing thru the bag walls and downwardly toward the hopper. The exhaust filtered air from the main feed air moving fan, at approximately 14.7 lb/in.², may be used to provide the cleaning air, however in a most preferred embodiment, the cleaning air at ambient atmospheric pressure is drawn directly from the atmosphere into a cleaning air plenum adapted to be placed into air flow communication with the open tops of the bags within a selected cell.

It is particularly noted that in a most preferred embodiment the main suction fan of the bag house is used to simultaneously provide the reverse cleaning air flow along with its main function as the system air moving device. In this regard, presently used fabric filter or cartridge duct collectors use an auxiliary device such as a compressor or a second fan to provide the cleaning air or gas under pressure to overcome the pressure of the main feed air stream and the upward momentum of the feed air molecules and particulates therein.

In a preferred method embodiment and with reference to the claims herein, the present cleaning method is employed in the operation of an air cleaning bag house having an upper filtered air outlet plenum, an ambient cleaning air plenum and a lower hopper section having a particulates discharge port, wherein an air feed stream passes into said hopper section, then thru the bag house and then exits from said outlet plenum, wherein said feed stream is maintained by suction fan means communicating with said outlet plenum, wherein the air pressure within said hopper section is less than ambient, wherein a plurality of elongated tubular air cleaning bags are supported substantially vertically in said hopper section by attachment of their open top ends to a cell plate, wherein the tubular walls of said bags and said cell plate divide said feed stream into an upstream dirty air component and a downstream filtered air component, and wherein the method is used for periodically dislodging particulates from the bag walls and impelling them downwardly toward a discharge port of said hopper section, and wherein

said method comprises establishing and maintaining a pressure drop of from about 1.0 in. spwg to about 6.0 in. spwg from said cleaning air plenum at ambient pressure to said hopper section, isolating one or more selected bags from said outlet plenum to cause the air pressure within said selected bags to equilibrate with the air pressure in said hopper section, placing the open top ends of said selected bags in air flow communication with said cleaning air plenum whereby the higher pressure cleaning air will flow into said selected bags and thru the walls thereof and downwardly in said lower pressure hopper section to thereby dislodge particulates from said bag walls and force them downwardly toward said discharge port, maintaining the flow of said cleaning air into said bags for a period, e.g., thirty seconds, sufficient to force at least about two bag volumes of said cleaning air thru the wall of each said bag, isolating said selected bags from said cleaning air plenum and restoring said feed stream to its operational on-line condition.

It is noted that the time period that a cell is off-line is quite variable dependent upon design parameters but it could be for seconds or minutes. In this regard, it is known and understood by those skilled in the art that certain particulates such as those having stickly or barbed surfaces or the like are more difficult to dislodge from fabric walls than others, therefore, such difficult particulates may require longer cleaning air flow periods, e.g., 1-5 minutes or more. Where the particulates are basically non-adhering, a few seconds of cleaning air flow would suffice to dislodge them.

A further factor which would bear on the flow period is the design of the bag house and its air flow characteristics. In particular, e.g., where a strong main suction fan is employed, the hopper pressure would likely be lowered and the pressure drop from the ambient air plenum to the hopper thereby increased such that the cleaning air volume flowing thru the bag walls per unit time would increase.

It is further noted that for the present invention the purpose is to allow for a dramatic increase in capacity with a similarly sized collector, i.e., the present design could increase the air handled through a unit by 100% to 200% for a minor cost increase. In this regard, for the standard CA (compressed air) cleaning of collectors (bags) the main air stream is not shut off at the bags and the bags are cleaned with short pulses of CA. This is by far the most common type of cleaning and does not provide a significant reverse air flow thru the bags. The air flow provided by CA is minimal and the time of pressure reversal is also minimal, in the range of 5 milli-seconds or so. As a result, most dislodged dust is immediately pulled back onto the filter or, in the non-typical case where the main air is shut off, the dust floats since it has minimal air flow or pressure influencing it. The present invention introduces outside, ambient air to force an air flow downwardly by reverse pressure for excellent cleaning results.

By way of the present unique construction and method, elimination of upward airflow of the feed airstream between off-stream bags during the cleaning cycle is essentially achieved. In currently used designs such upward flow of feed air is maintained since typically all of the bags are still on-stream. Therefore, a compromise in feed air flow rate must be met to allow for the collected dust to drop by gravity into the hopper when cleaning air is forced thru the bags being cleaned. This compromised reduction in main feed air velocity is a primary factor that limits higher air volume design capacity through a same-sized unit. In the present design, during the cleaning cycle, all air flow is downward between the bags being cleaned and thus eliminates the necessity of minimizing the main airstream velocity. Such unique operation permits significantly higher bag house air flow and filtering capacity. Also, with the partitions between cells, reentrainment of particulates in bags adjacent on-stream cells is essentially eliminated The downflow of cleaning air along with dislodged dust is directed down toward the hopper where, thru momentum and gravity, the dust drops towards the dust discharge port while the cleaning air flow enters with the main feed air flow stream.

In currently used designs, many applications have particulates which stay in suspension in the upper areas of the bags where they are repeatedly reentrained on the bags because of their very small size or low specific gravity or both and hence reside for a very long period of time in suspension. This “old” float dust is evacuated by the present design thereby permitting more bag filter area for the “new” particulates.

Further, bag life will increase with the present design which needs no strong cleaning air jet, since there will be no snapping or popping of the bags out from and back to the bag support cage. Such popping and rapid flexing is a significant cause of mechanical wear of bags. The present design which employs a substantially steady stream of cleaning air for a short period of time, e.g., preferably about 5-40 seconds, but could be of a much longer period, e.g., several minutes will relax the bags during cleaning by way of the reverse cleaning air holding the bags extended off of their cages (frames). The return of the relaxed bags back to their cages will be a gentle action as the cell is put back on stream and the operating pressure drop across the bag walls from inside to outside of the bags is reestablished.

In this regard and further with respect to the prior art, the Remillieaux U.S. Pat. No. 4,292,053 (above stated) or the standard pulse cleaning both work by the same principle which is a very brief reversal of pressure and a very small volume of cleaning air (inert gas for the Remillieaux process) flow. Because this reversal is so brief, in the range of 5 milliseconds, and the volume or air so small, very little dust is removed because most of the dust is reentrained back onto the filter media and/or the dust floats, especially the smaller particles, due to the lack of air flow except for the small, brief reversal. The present design provides a large flow of reverse air and pressure for a much longer period of time which evacuates the cell and removes a large amount of the collected particulates. This much more efficient cleaning means greatly reduces the cleaning frequency needed. This means that the cleaning hardware, i.e., valves, dampers, etc., require less maintenance. More importantly, the filter media life is extended considerably, as pulsing the filter media is the primary cause of wear and bag failure. In this regard, when the media is on-line, it is pulled taut against the wire support cage under suction. When it is pulsed, it is distended off of the cage so the media is flexed and then rapidly pulled back onto the cage when it goes back on line causing abrasion against the cage. So, the less pulsing, the longer the media.

### BRIEF DESCRIPTION OF THE DRAWINGS

The invention will be further understood from the drawings herein and description, wherein the various structures are not drawn to scale and wherein:

FIG. 1 is a top view of an exemplary or typical bag house embodying the present invention with portions broken away for clarity and typical placements for one group of bags shown in cell I, and wherein only a few exemplary bags are shown in cells II, III and IV.

FIG. 2 is a vertical cross-sectional view of the bag house taken along line 2-2 of FIG. 1 with certain portions shown in elevation and with only single bags in each row or group shown for clarity, and wherein the bag spacings shown are not necessarily in proportion to that of an actual installation;

FIGS. 3, 3A, 3B, 3C, 3D and 3E are partial sectional views showing examples of various commonly employed damper constructions and mountings useful in the present invention for regulating air flows;

FIG. 4 is a cross-sectional view of a bag top showing one of many typical structures useful with the present invention for suspending the filter bags from a typical tube sheet;

FIG. 5 is an isometric view of a bag house embodying the present invention; and

FIG. 6 is a cross-sectional view taken along line 6-6 of FIG. 5 but showing only four cells.

### DETAILED DESCRIPTION OF DRAWINGS

Referring to the drawings and with particular reference to the claims hereof, the present air cleaning installation or bag house generally designated 8 comprises a hopper 10 having a dirty air feed inlet 12 and a particle outlet 14. A collector housing 16 is positioned above the hopper and comprises wall means 15. A clean (filtered) air exhaust plenum 18 is positioned above the collector housing means and has a clean air outlet 20. A plurality of elongated, fabric filter bags 22 are supported on wire cages or frames 23 in conventional manner and are positioned substantially vertically in the collector housing and separate inlet 12 from exhaust plenum 18. An air moving fan 24 is provided on the installation downstream of the exhaust plenum for moving a feed air stream 25 progressively thru inlet 12, into hopper 10, thru the filter bag fabric 22 from the outside surfaces 28 to the inside 30 of the bags, thru exhaust plenum means 18 and out thru clean air outlet means 20. It is particularly noted that the term “bag(s)” as used herein, includes cartridge and other type filters which are commonly employed alternatively to bags. Such cartridge filters are constructed generally in configurations of automotive filters but are typically elongated. Another useful filter is the porous metal media type air filters well known to the art. The present invention is useful therefore, for reverse air cleaning any type of air filter which has a surface of filter material across which a pressure drop is normally impressed and on which surface particulates collect during filtration and thereby increase the pressure drop to undesirable levels.

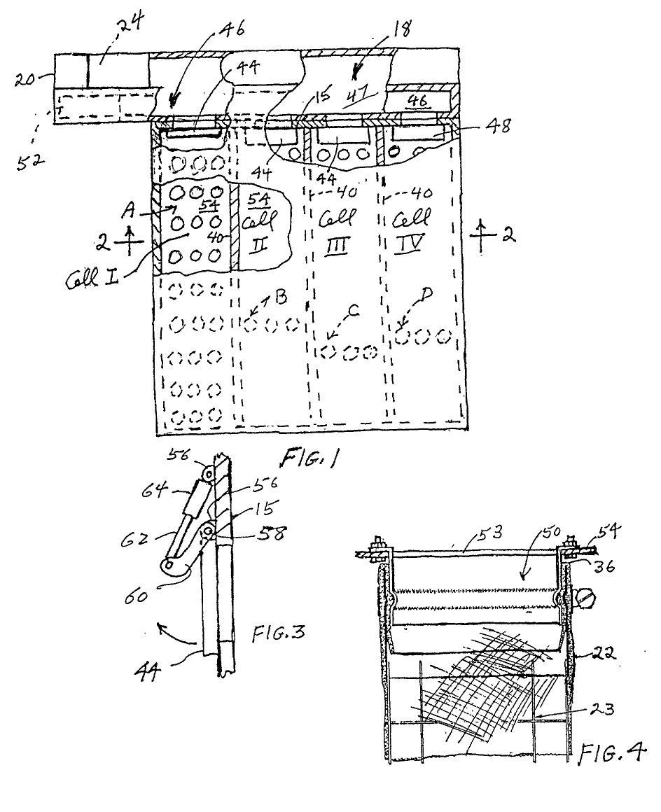

Thus, the feed air which flows into the bags during the filtering operation deposits particles 32 onto the exterior surfaces 28 of the bag fabric wall. The bags are separated into groups such as A, B, C and D (FIG. 1) substantially along their entire lengths from their tops 36 to adjacent their bottom ends 38 by substantially vertically oriented partitions 40 to provide air cells such as I, II, II, and IV for and containing each said group of bags. Each cell is open at the bottom 42 of the partitions for providing air flow communication with feed air stream 25. A first air flow control means (valve or damper) 44 is provided for exhaust plenum generally designated 18 for selectively taking each cell and its associated group of bags off-stream. A bag cleaning air plenum means generally designated 46 is provided and has a second air flow control means (valve or damper) 48 for placing the interiors of the off-stream bags thru their top openings 50 thereof into communication with reverse flow bag cleaning air 52 at a positive ambient air pressure with respect to the feed air suction pressure in the hopper below said bags, whereby the particles will be given a positive dislodging thrust outwardly and downwardly of the bags.

It is noted that the filtered air emitted at the outlet side 27 of fan 24 is considered to be ambient pressure of, e.g., 14.7 lb/in.², and can be used as cleaning air as fed into cleaning air plenum 46 as shown in FIG. 2. It is preferred however for simplification of structure and cost, that the cleaning air be taken into plenum 46 directly from outside of the bag house, i.e., at ambient temperature and pressure.

The bag tops 36 are mounted thru apertures 53 in a cell plate or tube sheet 54 in any known manner such as shown in the above cited prior art or in FIG. 4 hereof The bags can be manufactured of any of a variety of materials including porous paper, synthetic or natural fiber fabric, fiberglass fabric, perforated metal foil, fine wire cloth porous ceramic, carbon fiber fabric or the like, all of which are termed herein as “filter media”.

With respect to the plenum 18 and 46, an individual box like cover means 45 is positioned on said cell plate means over the open top 36 of the bags of each cell to provide both the exhaust plenum means and the cleaning air plenum means with an air flow passage means 47. These passage means 47 are in communication with all of the bags in their associated cell. For each exhaust plenum means its associated cover means 45 is provided with said first damper means 44 which is operable to selectively open and close passage means 47 to the atmosphere, and for each cleaning air plenum means its associated cover means is provided with second damper means 48 which is operable to selectively open and close passage means 47 to the atmosphere.

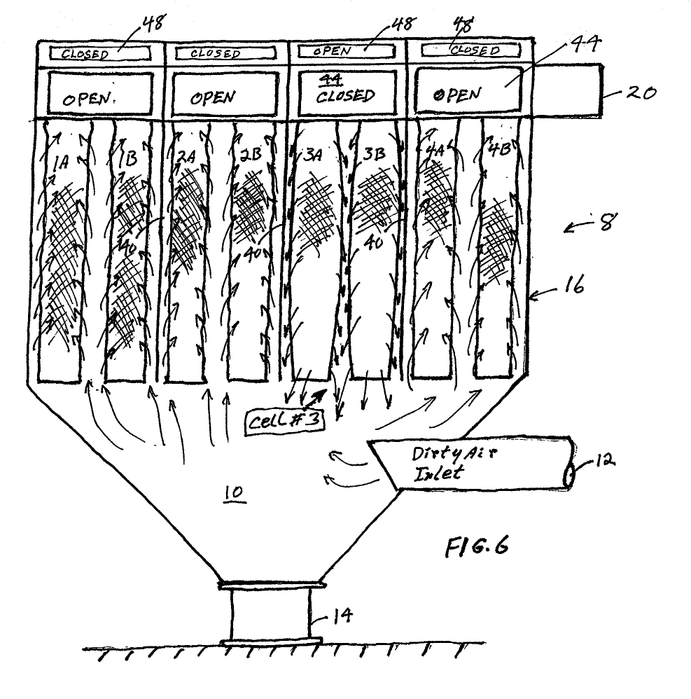

In this plenum construction, for each cleaning air plenum means its associated second damper means 48 may be placed in direct, immediate communication with the atmosphere alternatively, a second plenum can be provided exteriorly of said first and second damper means for each of the exhaust plenum means and cleaning air plenum means as shown in FIG. 5 and designated 49 and 51 respectively.

Referring to FIGS. 1 and 2, cell I is depicted as having just been taken off-stream by closing of its damper 44 and the entire cell is in a quiescent state with no significant movement of feed air or filtered air therein. At this stage, the floaters will begin to fall out toward the hopper by gravity. For purposes of illustration only, cell IV in this figure is depicted also as having been taken off-stream and opened to cleaning air by the opening of its damper 48 whereby the outward and downward flow of the cleaning air 52 is carrying dislodged particles as well as floaters down toward the hopper.

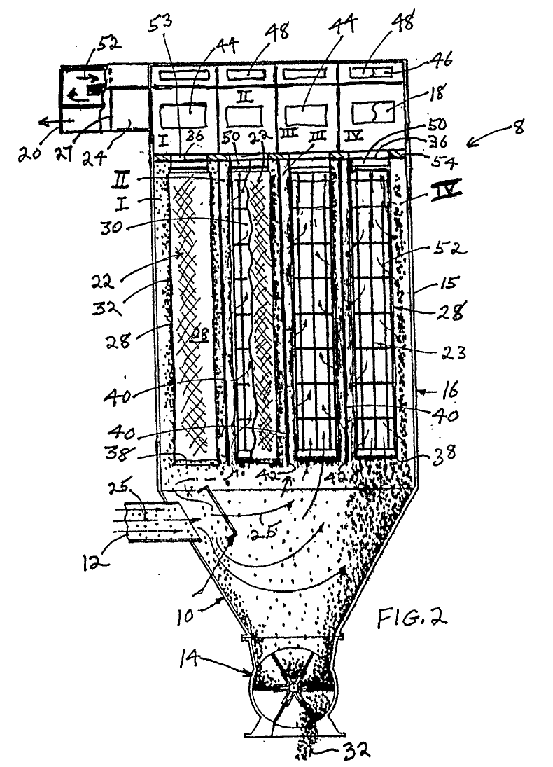

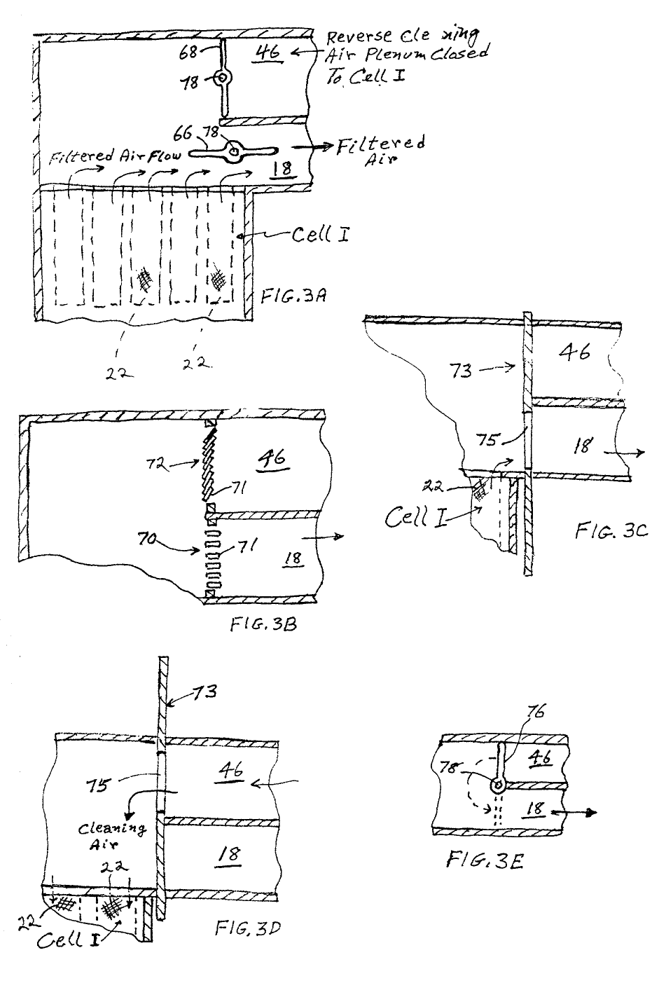

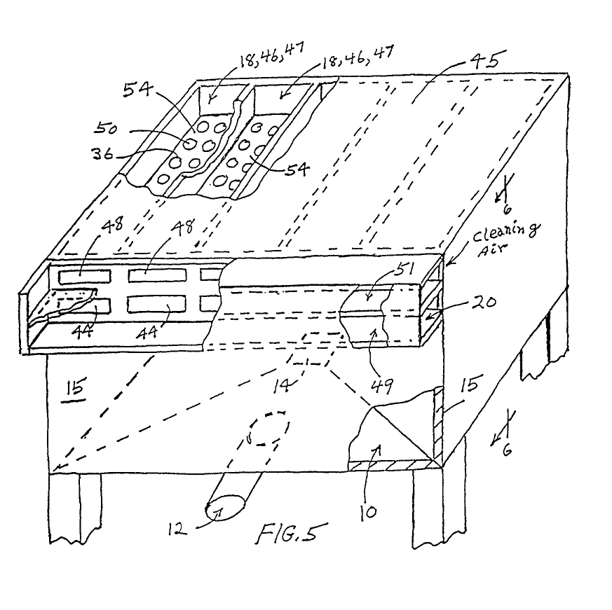

Referring to FIG. 3 wherein a lesser preferred air flow control system is shown, the dampers 44 and 48 or other such valving or flow control devices can be mounted on bearings 56 on wall 15 or other supporting structure by pins 58 to which are attached to crank arms 60 pivotally attached to pistons or armatures 62 of power means such as cylinders or solenoids 64 which are pivotally mounted on 15, also by bearings such as 56.

Referring to FIGS. 3A, 3B, 3C, 3D and 3E, the air flow control devices shown therein are preferred and the bag house structures shown therein are only generally described. In these Figs., the reverse cleaning air plenum and the filtered air exhaust plenum are, for purposes of illustration only, considered to be associated with and adapted to be placed in communication with the same cell. In FIG. 3A, butterfly dampers 66 and 68 mounted on shafts 78 are employed to open and close the filtered exhaust air plenum 18 and the reverse cleaning air plenum 46 respectively to the cell. In FIG. 3B, louvered dampers 70 and 72 respectively are used for that purpose, wherein, as shown, the louvers 71 of 70 are open and of 72 are closed. In FIGS. 3C and 3D, a sliding gate or wall member 73 having an air flow port 75 is slidably mounted either generally horizontally or generally vertically in slide guide means in plenums 18 and 46 for selectively opening or closing these plenums to the cell as required. In FIG. 3E the single flap 76 can be pivoted around shaft 78 to close or open either plenum 18 or 48 to the bags.

The power means for operating any of the dampers or valving shown in FIGS. 3, 3A, 3B, 3C, 3D or 3E can be mechanical or electrical, pneumatic or hydraulic and can be manually actuated or connected to remote control devices for actuation, for example, in response to computerized bag cleaning programming and/or to signals from devices which measure pressure drops or the like across the bags.

In a typical air cleaning installation employing the present invention, an example of approximate structural dimensions and operating parameters, wherein negative pressures are less than atmospheric and are given in standard pressure water gauge (spwg), are as follows:

| | | | |
|---|---|---|---|
| 1. | Hopper capacity | 200 | ft³ |
| 2. | Air feed rate into hopper | 3500 | ft/min. |
| 3. | Air volume flow rate into hopper | 10,000 | CFM |
| 4. | Static negative pressure in hopper | 4 | in. spwg |
| 5. | Area of tube sheet | 88 | ft² |
| 6. | Total Number of filter bags | 112 | |
| 7. | Filter cloth wall area of each bag | 10 | ft² |
| 8. | Diameter of each bag | 4.0 | in. |
| 9. | Bag Volume, Per Bag | 0.87 | ft³ |
| 10. | Cleaning air flow per bag per cleaning cycle | 10-50 | CFM |
| 11. | Duration of cleaning air flow per cleaning cycle | 5-60 | sec. |
| 12. | Number of cells | 8 | |
| 13. | Desirable spacing between adjacent bags | 1.0-5.0 | in. |
| | in each cell | | |
| 14. | Number of bags in each cell | 14 | |
| 15. | Bag length from top to bottom | 120 | in. |
| 16. | Partition wall length from top to bottom | 120 | in. |
| 17. | Filtered air plenum total volume | 60 | ft³ |
| 18. | Static negative pressure in filtered air plenum | 7.0 | in spwg |
| 19. | Air pressure at outlet of air moving means | ˜14.7 | lbs/in². |
| | (e.g. fan) | | |

In regard to items 10 and 11 above, the following are specific examples of average cleaning air volumes at 10 CFM and 50 CFM according to the present invention for a one minute cleaning cycle and a five second cleaning cycle for an off-stream bag having a total cloth wall area of 10 ft.².

### Cleaning Air Vol./Cycle

5 sec. cycle @ 10.0 CFM=0.83 ft.³

1 min. cycle @ 10.0 CFM=10.00 ft.³

5 sec. cycle @ 50.0 CFM=4.15 ft.³

1 min. cycle @ 50.0 CFM=50.0 ft.³

These air volumes are not meant to be restrictive as to air volumes which may be found to be required for a particular installations or particular feed stream compositions, and the cleaning cycle periods may have to be lengthened to give the desired cleaning.

The invention has been described in detail with particular reference to preferred embodiments thereof, but it will be understood that variations and modifications will be effected with the spirit and scope of the invention.

I claim:

1. A filter bag cleaning method for use in an air cleaning bag house installation in which feed air from a manufacturing or the like operation containing filterable particles is sucked by air moving means to from a feed stream which enters into a hopper and into contact with fabric walled filter bags mounted in a collector housing positioned above said hopper, wherein said stream flows from the higher pressure outside of the bags to the lower pressure inside of the bags thru the bag fabric walls during the filtering operation such that the particles becomes loosely attached to the bag fabric exterior surfaces, wherein the bags are separated into groups by partition means which provide separate cell means for and containing each group of bags, wherein each of a filtered air outlet plenum means and a bag cleaning air plenum means are provided and are adapted to be selectively placed in or taken out of air flow communication with the inside of each said bag of each said group by air flow control damper means, said partition means being configured to allow each cell means to be in air flow communication with said feed stream, and wherein each said cell means and its associated group of bags can be taken selectively off-stream by operation of said air flow control damper means for cleaning purposes or the like without shutting down other cell means,
said bag cleaning method comprising selectively taking a cell means off-stream by first damper means by (1) closing the bags to said outlet plenum, (2) substantially simultaneously with (1) opening the bags to said cleaning air plenum by second damper means, (3) after the cleaning cycle closing the bags to said cleaning air plenum by said second damper means, and (4) substantially simultaneously with (3) opening said bags to said outlet plenum, whereby in step (1) the air pressure inside and outside the off-stream bags is substantially equilibrated to the pressure within said hopper and air movement within the cell means substantially ceases such that lighter particles (floaters) will start to gravitate downwardly toward the hopper, whereby in step (2) substantially immediately after step (1) the interiors of said off-stream bags are placed into communication with ambient cleaning air at a positive pressure with respect to said hopper pressure by operation of said second damper means whereby a bag cleaning reverse air flow of steadily increasing flow rate will be established across the off-stream bag fabric walls and drawn downwardly in said cell means whereby said particles will be given a positive and continuing dislodging thrust outwardly of said off-stream bags and downwardly in the cell means toward said hopper, wherein the flow period of said reverse air flow into said off-stream bags is at least about 5 seconds at an average flow rate per bag of from about 1.0 CFM to about 18.0 CFM per 10 ft². of filter cloth wall area of said bag.

2. The method of claim 1 wherein the bags are of substantially the same length and elevation, and wherein the bag cleaning air flowing outwardly thru and downwardly from said off-stream bags is caused to enter into said feed stream below lower portions of said off-stream bags such as to substantially prevent reentrainment of dust at upper portions of adjacent on-stream bags.

3. The method of claim 1 wherein the period of said reverse cleaning air flow is from about 10 to about 40 seconds.

4. The method of claim 1 wherein the static air pressure drop from said hopper to said outlet plenum means is from about 2.0 to about 4.5 in. spwg.

5. The method of claim 1 wherein during the normal filtering operation of the bag house installation the static pressure drop of feed air across the filter bags ranges from about 1.0 in. spwg to about 2.0 in. spwg, and during the cleaning operation the static pressure drop of the reverse cleaning air across the filter bags ranges from about 1.0 in. spwg to about 6.0 in. spwg.

6. In the operation of an air cleaning bag house having an upper filtered air outlet section, an ambient cleaning air inlet section, a collector section and a lower hopper section, wherein an air feed stream passes into said hopper section, then thru the bag house and then exits said outlet section, wherein said feed stream is maintained by suction fan means communicating with said outlet section, wherein the air pressure within said hopper section is less than ambient, wherein a plurality of elongated tubular air cleaning bags are supported substantially vertically in said collector section by attachment of their open top ends to a cell plate, wherein the tubular walls of said bags and said cell plate divide said feed stream into an upstream dirty air component and a downstream filtered air component, and wherein is employed
the method for periodically dislodging particulates from the bag walls and impelling them downwardly toward a discharge port of said hopper section, said method comprising establishing and maintaining a static air pressure drop of from about 1.0 in. spwg to about 6.0 in. spwg from said cleaning air inlet section at ambient pressure to said hopper section, isolating one or more selected bags from said filtered air outlet section to cause the static air pressure within said selected bags to equilibrate with the static air pressure in said hopper section, placing the open top ends of said selected bags in air flow communication with said cleaning air inlet section whereby the higher pressure cleaning air will flow into said selected bags and thru the walls thereof and downwardly in said lower pressure hopper section to thereby dislodge particulates from said bag walls and carry them downwardly toward said discharge port, maintaining the flow of said cleaning air into said bags for a period sufficient to force at least two bag volumes of said cleaning air thru the wall of each said bag, isolating said selected bags from said cleaning air inlet section and placing the open top ends of said selected bags in air flow communication with said filtered air outlet section to thereby restore said feed stream to its operational on-line condition.

7. The method for operating the air flow dampers of a bag house to enhance the bag cleaning process, wherein the bag house has a feed air inlet hopper positioned below a filtered outlet plenum, wherein the hopper and plenum are separated by filter bags, wherein under normal operation the pressure in said hopper is less than ambient, said method comprising the steps of (1) closing off one or more selected bags to said filtered air outlet plenum, (2) opening up said selected bag(s) to an ambient cleaning air plenum to cause a reverse cleaning air flow thru said bag(s) and into said hopper for a cleaning period of at least about five seconds, (3) closing off said selected bag(s) to said cleaning air plenum and (4) opening up said bag(s) to said outlet plenum to restore normal feed air flow from said hopper thru said bag(s) and into said outlet plenum.

8. The method of claim 7 wherein steps (1) and (2) are carried out substantially simultaneously and wherein steps (3) and (4) are carried out substantially simultaneously.

9. The method of claim 8 wherein the diminished pressure in said hopper is effected by a suction fan means communicating with said outlet plenum, and wherein said fan is the main air moving device employed in the bag house.

10. The method of claim 9 wherein the pressure drop from said cleaning air plenum to said hopper across said selected bag(s) is from about 0.1 in. spwg to about 6.0 in. spwg.

11. An air cleaning bag house comprising a hopper having a dirty air feed inlet and a particle discharge port, a collector housing positioned above said hopper, filtered air exhaust plenum means positioned above said collector housing and having filtered air outlet means, cell plate means positioned between said collector housing and said exhaust plenum means, a plurality of elongated, tubular fabric filter bags connected at their open tops to said cell plate means and depending substantially vertically therefrom within said collector housing, said cell plate means and said bags separating said inlet from said exhaust plenum means, suction fan means communicating with said outlet means for moving feed air progressively thru said inlet into said hopper, thru the filter bag fabric from the outside to the inside of the bags, thru said exhaust plenum means and out thru said outlet means, whereby said feed air which flows into the bags during the filtering operation deposits particles onto the exterior surfaces of the bag fabric, said bags being separated into groups substantially along their entire lengths from their top ends to adjacent their bottom ends by means of substantially vertically oriented partition means to provide an air cell for and containing each group of bags, each said cell being open at the bottom of said partition means for providing air flow communication of each said cell with said feed air, first air flow control means in said exhaust plenum means for selectively taking each said cell and its associated group of bags off-stream and for placing them back on-stream, bag cleaning air plenum means in said bag house and in communication with ambient cleaning air at atmospheric pressure, second air flow control means in said cleaning air plenum means for placing the interiors of the off-stream bags thru the open tops thereof into communication with reverse flow ambient bag cleaning air at a positive pressure with respect to the feed air pressure in said hopper, whereby said particles will be given a positive dislodging thrust outwardly and downwardly of said bags, and wherein said second air flow control means is adapted to close off said open tops to said cleaning air.

12. The bag house of claim 11 wherein an individual box like cover means is positioned on said cell plate means over said open tops of said bags of each cell to provide both said exhaust plenum means and said cleaning air plenum means with an air flow passage means in communication with all of the bags in each cell, wherein for each exhaust plenum means its associated cover means is provided with first damper means which is operable to selectively open and close said passage means to the atmosphere, and wherein for each cover means is provided with second damper means which is operable to selectively open and close said passage means to the atmosphere.

13. The bag house of claim 12 wherein for each cleaning air plenum means its associated said second damper means is in direct, immediate communication with the atmosphere.

14. The bag house of claim 13 wherein each said cleaning air plenum means is adapted for air flow generation within said bag house only by means of the less than ambient air pressure within said hopper.

15. The bag house of claim 12 wherein a secondary plenum is provided exteriorly of said first and second damper means for each of said exhaust plenum means and cleaning air plenum means.

16. The method of claim 7 wherein the ambient cleaning air has been conditioned to modify its temperature and/or humidity.
